(19) United States
(12) Patent Application Publication
(10) Pub. No.: US 2012/0134362 A1
(43) Pub. Date: May 31, 2012

(54) RECEIVER, RECEPTION METHOD, PROGRAM AND COMMUNICATION SYSTEM

(75) Inventors: Takeshi Itagaki, Saitama (JP); Tomoya Yamaura, Tokyo (JP)

(73) Assignee: SONY CORPORATION, Tokyo (JP)

(21) Appl. No.: 13/295,184

(22) Filed: Nov. 14, 2011

(30) Foreign Application Priority Data
Nov. 25, 2010 (JP) P2010-262782

(51) Int. Cl. H04L 12/56

(52) U.S. Cl. 370/394; 370/389

(57) ABSTRACT

Disclosed herein is a receiver including: a reception section adapted to sequentially receive a plurality of packets from a transmitter; a first processing section adapted to output a predetermined number of packets received by the reception section all together if the predetermined number of packets are received without any loss by the reception section; a second processing section adapted to accept the predetermined number of packets output all together from the first processing section; a detection section adapted to detect a predetermined request; and a control section adapted to control the first processing section to output a packet, received by the reception section, to the second processing section each time the reception section receives a packet if the detection section detects the predetermined request.

### BACKGROUND

The present disclosure relates to a receiver, reception method, program and communication system.

Wireless LANs (Local Area Networks) have become widespread in recent years as LANs adapted to achieve data exchange through wireless communication. On the other hand, IEEE802.11 (hereinafter may be simply referred to as “802.11”) developed by IEEE (Institute of Electrical and Electronic Engineers) is known as a wireless LAN standard. Various techniques have been disclosed as techniques based on 802.11 (refer, for example, to Japanese Patent Laid-Open No. 2009-278542).

802.11 defines an arrangement for a transmitter to transmit a plurality of packets in a connecting manner to a receiver and for the receiver to combine acknowledge packets (hereinafter also referred to as an “Ack”) for the received packets into a single packet and return this packet to the transmitter so as to ensure reduced transmission overhead for faster transmission. A technique used by a transmitter to join a plurality of packets together is particularly referred to as “packet aggregation,” and an Ack packet into which a plurality of Ack packets are combined by a receiver is particularly referred to as a “block Ack.”

The throughput enhancement technique as described above differs from a technique in which the transmitter transmits a next packet to the receiver after confirming the receipt of an Ack packet from the receiver. Therefore, a received packet and an Ack packet are not paired in the receiver. As a result, received packets are not necessarily inserted into the queue in a normal sequence in the receiver.

In order to ensure that packets are output to the upper layer in the receiver in a normal sequence, therefore, 802.11 defines that a sequence control process (hereinafter also referred to as “re-ordering process”) is performed on packets in the Media Access Control (MAC) layer. More specifically, packets are temporarily stored at the MAC layer first and then output to the upper layer to ensure packet transfer to the upper layer in the order of sequence numbers. The above process allows for communication without being aware of the sequence of packets at the upper layer.

### SUMMARY

However, if the above process is performed, and if a packet cannot be received due, for example, to an error, properly received packets wait at the MAC layer until a packet whose reception failed is received properly as a result of retransmission from the transmitter.

For example, if an application is executed in which the extent to which packets are delayed should be maintained low as with an application for which realtimeness is important, there is a likelihood that the time limits of some packets, which have reached the MAC layer without mishap, may expire because these packets fail to reach the upper layer due to a delay caused by the sequence control process. This phenomenon likely occurs particularly if packets are transmitted to the receiver based on an algorithm in which the transmitter transmits a packet to be retransmitted later than packets to be transmitted for the first time.

In light of the foregoing, it is desirable to provide a new and improved technique that can prevent received packets from waiting at the lower layer in the receiver until a packet whose reception from the transmitter failed is received properly as a result of retransmission.

According to an embodiment of the present disclosure, there is provided a receiver that includes a reception section, first and second processing sections, detection section and control section. The reception section sequentially receives a plurality of packets from a transmitter. If a predetermined number of packets are received without any loss by the reception section, the first processing section outputs the predetermined number of packets received by the reception section all together. The second processing section accepts the predetermined number of packets output all together from the first processing section. The detection section detects a predetermined request. If the detection section detects the predetermined request, the control section controls the first processing section to output a packet, received by the reception section, to the second processing section each time the reception section receives a packet.

The second processing section may perform a predetermined process on the predetermined number of packets output from the first processing section before the detection of the predetermined request by the detection section, and perform a predetermined process on the packet output from the first processing section after the detection of the predetermined request by the detection section.

If the first processing section is controlled by the control section to output a packet, received by the reception section, to the second processing section each time the reception section receives a packet, the second processing section may recover a packet not output from the first processing section.

If the reception section further receives, from the transmitter, a calculation result obtained by calculating the bit-by-bit exclusive OR of the predetermined number of packets, the second processing section may recover a packet not output from the first processing section by calculating the bit-by-bit exclusive OR of the plurality of packets output from the first processing section and the calculation result.

If a sequence number is assigned to each of the plurality of packets transmitted from the transmitter, the first processing section may determine whether the predetermined number of packets have been received without any loss based on the sequence number assigned to each of the plurality of packets.

The receiver may further include an input section adapted to accept an operation signal input from the user. The detection section may detect the predetermined request based on the operation signal accepted by the input section.

The reception section may further receive a predetermined message from the transmitter for notification of the predetermined request, and the detection section may detect the predetermined request based on the predetermined message received by the reception section from the transmitter.

The detection section may detect the predetermined request based on the setting in a predetermined field of each of the plurality of packets received by the reception section from the transmitter.

If device identification information adapted to identify the transmitter is included in the predetermined request, the detection section may further detect the device identification information from the predetermined request. The control section may control the first processing section to output a packet, received by the reception section, to the second processing section each time the reception section receives a packet from the transmitter identified by the device identification information.

If type information indicating the type of the packet is included in the predetermined request, the detection section may further detect the type information from the predetermined request. The control section may control the first processing section to output a packet, received by the reception section, to the second processing section each time the reception section receives a packet whose type is indicated by the type information.

The receiver may further include a transmission section adapted to transmit a response packet to the transmitter in response to the predetermined number of packets transmitted from the transmitter irrespective of whether the detection section has yet to detect or has already detected the predetermined request.

The first processing section may determine whether there is any missing packet that has not been received by the reception section, among the predetermined number of packets. The same section may set a sequence number for the missing packet in the response packet if the same section determines that there is a missing packet. On the other hand, the same section may set, in the response packet, information indicating that the packets have been received without any loss when the same section determines that there is no missing packet.

If the missing packet is retransmitted from the transmitter based on the sequence number set in the response packet, the reception section may receive the missing packet. If the first processing section is controlled by the control section to output a packet, received by the reception section, to the second processing section each time the reception section receives a packet, the second processing section may recover a packet not output from the first processing section and discard the missing packet received by the reception section.

According to another embodiment of the present disclosure, there is provided a reception method including sequentially receiving a plurality of packets from a transmitter, outputting a predetermined number of packets all together if the predetermined number of packets are received without any loss by the reception section, accepting the predetermined number of packets output all together, detecting a predetermined request, and controlling to output a received packet each time the packet is received if the predetermined request is detected.

According to still another embodiment of the present disclosure, there is provided a program causing a computer to function as a receiver, the receiver including: a reception section adapted to sequentially receive a plurality of packets from a transmitter; a first processing section adapted to output a predetermined number of packets received by the reception section all together if the predetermined number of packets are received without any loss by the reception section; a second processing section adapted to accept the predetermined number of packets output all together from the first processing section; a detection section adapted to detect a predetermined request; and a control section adapted to control the first processing section to output a packet, received by the reception section, to the second processing section each time the reception section receives a packet if the detection section detects the predetermined request.

According to still another embodiment of the present disclosure, there is provided a communication system including a transmitter, and a receiver. The transmitter includes a transmission section adapted to sequentially transmit a plurality of packets. The receiver includes a reception section adapted to sequentially receive a plurality of packets from a transmitter, a first processing section adapted to output a predetermined number of packets received by the reception section all together if the predetermined number of packets are received without any loss by the reception section, a second processing section adapted to accept the predetermined number of packets output all together from the first processing section, a detection section adapted to detect a predetermined request, and a control section adapted to control the first processing section to output a packet, received by the reception section, to the second processing section each time the reception section receives a packet if the detection section detects the predetermined request.

As described above, the present disclosure makes it possible to prevent received packets from waiting at the lower layer in the receiver until a packet whose reception from the transmitter failed once is received properly as a result of retransmission in response to a predetermined request.

### BRIEF DESCRIPTION OF THE DRAWINGS

FIG. 1 is a diagram illustrating the configuration of a communication system according to an embodiment of the present disclosure;

FIG. 2 is a diagram illustrating configuration examples of frames applicable to the same embodiment;

FIG. 3 is a diagram illustrating the functional configuration of a receiver according to the same embodiment;

FIG. 4 is a diagram illustrating the functional configuration of a transmitter according to the same embodiment;

FIG. 5 is a flowchart illustrating the flow of a process performed by the communication system according to the same embodiment;

FIG. 6 is a diagram illustrating an example of a selection screen displayed by the receiver according to the same embodiment;

FIG. 7 is a diagram illustrating a configuration example of a data frame (including an IP header) applicable to the same embodiment;

FIG. 8 is a diagram illustrating a configuration example of a data frame (including an RTP header) applicable to the same embodiment;

FIG. 9 is a diagram illustrating a configuration example of a management action frame applicable to the same embodiment;

FIG. 10 is a diagram illustrating a configuration example of a data frame (including a message field) applicable to the same embodiment;

FIG. 11 is a diagram for describing the recovery of a missing packet by the receiver according to the same embodiment;

FIG. 12 is a diagram illustrating an example of flow of packets transmitted and received by the communication system according to the same embodiment (before the detection of a predetermined request); and

FIG. 13 is a diagram illustrating an example of flow of packets transmitted and received by the communication system according to the same embodiment (after the detection of a predetermined request).

### DETAILED DESCRIPTION OF THE PREFERRED EMBODIMENT

A detailed description will be given below of the preferred embodiment of the present disclosure with reference to the accompanying drawings. It should be noted that the components having substantially the same functional configuration are designated by the same reference numerals, and that redundant description is omitted.

Further, the “embodiment for carrying out the present disclosure” will be described in the following order.

1. Embodiment
1-1. Configuration of the communication system
1-2. Frame configuration
1-3. Functional configuration of the receiver
1-4. Functional configuration of the transmitter
1-5. Process performed by the communication system
1-6. Detection of a predetermined request based on user input
1-7. Detection of a predetermined request based on the setting in a predetermined field
1-8. Detection of a predetermined request based on reception of a dedicated message
1-9. Recovery of a missing packet
1-10. Flow of packets transmitted and received before the detection of a predetermined request
1-11. Flow of packets transmitted and received after the detection of a predetermined request

2. Modification example

3. Summary

### 1. EMBODIMENT

### 1-1. Configuration of the Communication System

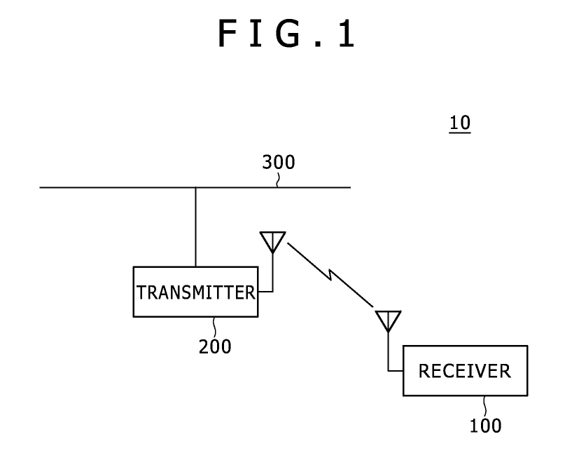

FIG. 1 is a diagram illustrating the configuration of a communication system according to an embodiment of the present disclosure. A description will be given first of the configuration of the communication system according to the embodiment of the present disclosure with reference to FIG. 1.

A communication system 10 according to the embodiment of the present disclosure includes a receiver 100 and transmitter 200 as illustrated in FIG. 1. The receiver 100 and transmitter 200 can communicate with each other, for example, by using a wireless signal. However, the receiver 100 and transmitter 200 may be connected in a wired manner. The transmitter 200 may be able to communicate with other devices, for example, via a network 300 such as LAN.

The receiver 100 and transmitter 200 may be combined in any form. Further, data may be transmitted from the transmitter 200 to the receiver 100 by using, for example, an uplink, downlink, direct link or adhoc network. In the present embodiment, a description will be given of a case in which data is communicated from the transmitter 200 to the receiver 100 by using a downlink assuming, for example, that the receiver 100 is an AP (access point) and that the transmitter 200 is an ST (station). Although, in the present embodiment, an example will be described in particular in which the receiver 100 and transmitter 200 communicate with each other based on 802.11, the protocol used for communication between the receiver 100 and transmitter 200 is not specifically restricted.

### 1-2. Frame Configuration

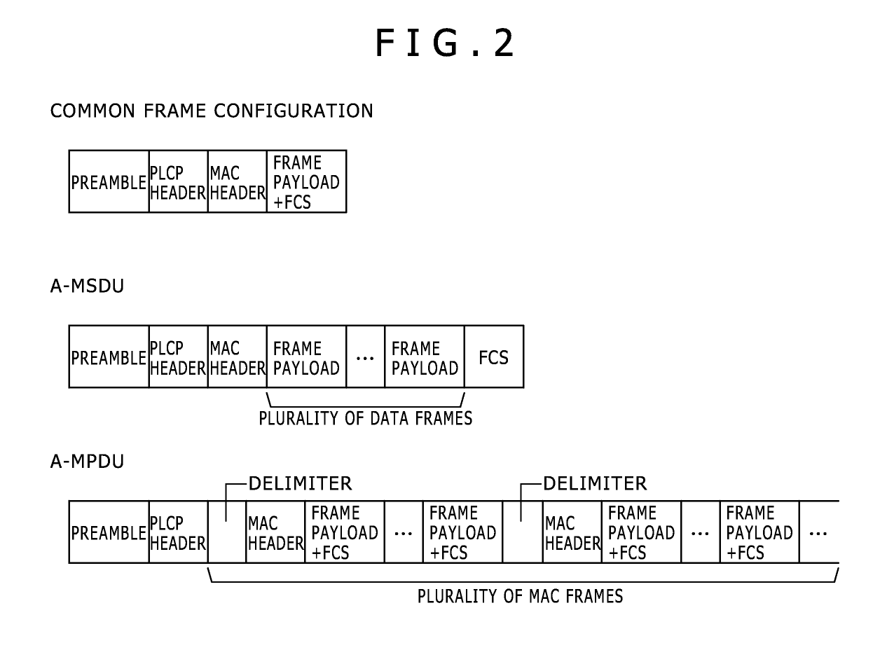

FIG. 2 is a diagram illustrating configuration examples of frames applicable to the embodiment of the present disclosure. A description will be given below of the configuration examples of frames applicable to the embodiment of the present disclosure with reference to FIG. 2.

As illustrated in FIG. 2, a frame commonly exchanged between the receiver 100 and transmitter 200 includes, for example, a preamble, PLCP (physical layer convergence protocol) header, MAC (Media Access Control) header and frame payload with FCS (Frame Check Sequence).

The preamble is a field used to detect a timing and estimate a carrier frequency offset. The preamble is attached to the frame payload at the physical layer in the transmitter 200 and then referenced and removed at the physical layer in the receiver 100 from the frame payload. The PLCP header is a field used to specify a modulation scheme. This header is attached to the frame payload at the physical layer in the transmitter 200 and then referenced and removed at the physical layer in the receiver 100 from the frame payload. The MAC header is attached to the frame payload at the MAC layer in the transmitter 200 and then referenced and removed at the MAC layer in the receiver 100 from the frame payload.

The frame payload is generated at the layer above the MAC layer in the transmitter 200 and referenced at the layer above the MAC layer in the receiver 100. The frame payload includes, for example, a TCP (Transmission Control Protocol) packet and IP packet (Internet Protocol) packet. In the description given below, the frame payload may be simply referred to as a packet. The FCS is used to detect a missing packet among packets transmitted from the transmitter 200 to the receiver 100. The FCS is attached to the frame payload at the layer above the MAC layer in the transmitter 200 and referenced at the layer above the MAC layer in the receiver 100.

In the present embodiment, the transmitter 200 transmits a plurality of frames in a joined-together manner to the receiver 100. Various forms are possible as a plurality of frames that are joined together. As illustrated in FIG. 2, for example, an A-MSDU (Aggregation-Mac Service Data Unit) frame is a possible form of a plurality of frames that are joined together. In the A-MSDU frame, a common header is set as a preamble, PLCP header and MAC header, followed by frame payloads, one for each of a plurality of frames, arranged in succession.

Further, as illustrated in FIG. 2, for example, an A-MPDU (Aggregation-Mac Protocol Data Unit) frame is also a possible form of a plurality of frames that are joined together. In the A-MPDU frame, a common header is set as a preamble and PLCP header, followed by a MAC header and a plurality of frame payloads arranged in succession.

### 1-3. Functional Configuration of the Receiver

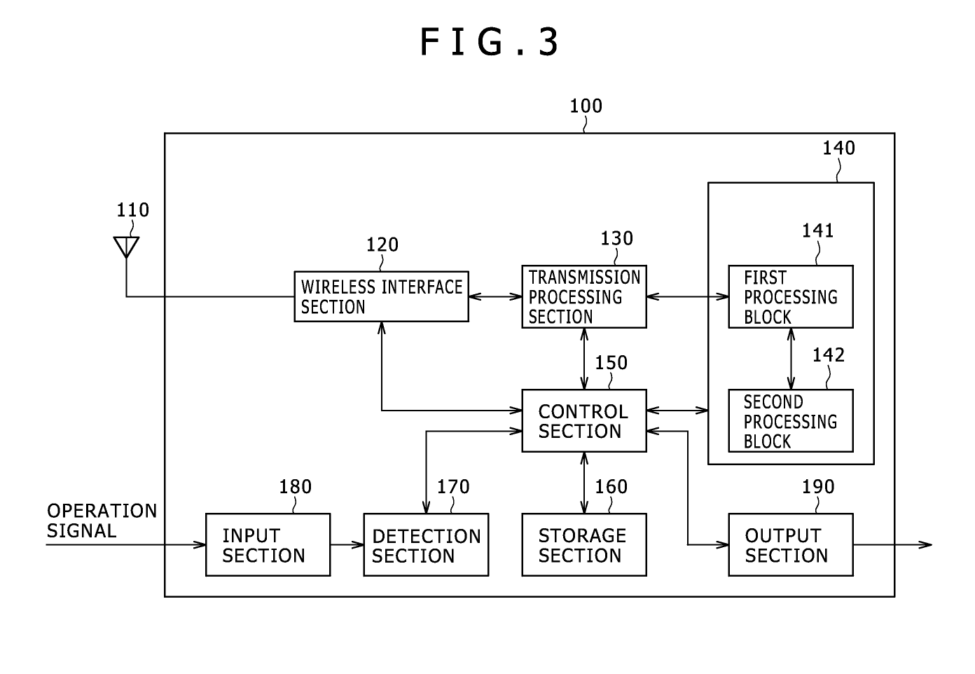

FIG. 3 is a diagram illustrating the functional configuration of the receiver 100 according to the embodiment of the present disclosure. A description will be given below of the functional configuration of the receiver 100 according to the embodiment of the present disclosure with reference to FIG. 3.

As illustrated in FIG. 3, the receiver 100 according to the embodiment of the present disclosure includes at least a reception section 110, data processing section 140, detection section 170 and control section 150. The receiver 100 further includes, for example, a wireless interface section 120, transmission processing section 130, storage section 160, input section 180 and output section 190 as necessary.

The reception section 110 is capable of sequentially receiving a plurality of packets from the transmitter 200. Here, each of the plurality of packets sequentially received by the reception section 110 from the transmitter 200 is equivalent to a frame payload in the example shown in FIG. 2. A preamble, PLCP header, MAC header and so on are attached to or removed from the frame payload as appropriate. For example, the receiver 100 receives a plurality of packets in the form of an A-MSDU, A-MPDU or other frame. The reception section 110 includes, for example, an antenna as illustrated in FIG. 3. However, the same section 110 may include other communication device.

The data processing section 140 includes at least first and second processing blocks 141 and 142. If a predetermined number of packets are received without any loss by the reception section 110, the first processing block 141 is capable of outputting the predetermined number of packets received by the reception section 110 all together to the second processing block 142. The first processing block 141 is equivalent to the MAC layer. The predetermined number is not specifically restricted and may be any number so long as the number of packets is two or more. More specifically, if, for example, packets received by the reception section 110 are temporarily stored in a buffer by the transmission processing section 130, the first processing block 141 references the packets stored in the buffer. When verifying that the predetermined number of packets are stored without any loss in the buffer, the same block 141 outputs the predetermined number of packets to the second processing block 142. The memory provided in the receiver 100, for example, is used as the buffer.

Whether the predetermined number of packets have been received can be determined by the first processing block 141 in a variety of manners. If, for example, a sequence number is assigned to each of a plurality of packets transmitted from the transmitter 200, the first processing block 141 can determine whether the predetermined number of packets have been received without any loss based on the sequence numbers assigned to the plurality of packets.

The second processing block 142 is capable of accepting the predetermined number of packets output all together from the first processing block 141. The second processing block 142 is equivalent to the layer above the MAC layer. The same block 142 performs a predetermined process on the predetermined number of packets output from the first processing block 141 before the detection of a predetermined request by the detection section 170. On the other hand, the same block 142 performs a predetermined process on a packet output from the first processing block 141 after the detection of the predetermined request by the detection section 170. The predetermined process is not specifically restricted, but determined, for example, according to the program for implementing the second processing block 142. One possible form of the predetermined process is to display data set in the frame payload area of each of the predetermined number of packets output from the first processing block 141. Another possible form of the predetermined process is to reproduce the data.

The detection section 170 is capable of detecting a predetermined request. A predetermined request is equivalent to a low delay request made from the layer above the MAC layer. The term “low delay request” refers, for example, to a request indicating that the processing delay should be maintained low. Although a detailed description will be given later of how a predetermined request is detected, a predetermined request is detected, for example, based on user input. Alternatively, a predetermined request may be detected based on the setting in a predetermined field of the packet used for data transmission from the transmitter 200 to the receiver 100. Still alternatively, a predetermined request may be detected based on reception of a dedicated message from the transmitter 200. Although FIG. 3 shows an example in which the detection section 170 detects a predetermined request output from the input section 180, the component adapted to output a predetermined request to the detection section 170 is not limited to the input section 180. Further, the format of a predetermined request is not specifically restricted.

The control section 150 is capable of controlling the operation of each of the functional blocks of the receiver 100. If, for example, the detection section 170 detects a predetermined request, the control section 150 is capable of controlling the first processing block 141 to output a packet, received by the reception section 110, to the second processing block 142 each time the reception section 110 receives a packet. Moreover, if a predetermined number of packets are received without any loss by the reception section 110 before the detection of a predetermined request by the detection section 170, the control section 150 is capable of controlling the first processing block 141 to output a predetermined number of packets received by the reception section 110 all together to the second processing block 142.

The data processing section 140, control section 150 and detection section 170 include, for example, a CPU (Central Processing Unit) and RAM (Random Access Memory). The functionality of these sections is implemented as a result of loading of the program, stored in the storage section 160, into the RAM and execution of the same program by the CPU. However, the data processing section 140, control section 150 and detection section 170 are not limited to this configuration and may include dedicated software.

The functionality of the reception section 110, the first and second processing blocks 141 and 142, control section 150 and detection section 170 makes it possible to prevent received packets from waiting at the lower layer in the receiver 100 until a packet whose reception from the transmitter 200 failed once is received properly as a result of retransmission in response to a predetermined request.

Even if, for example, the detection section 170 detects a predetermined request, the control section 150 may, depending on the packet type, control the first processing block 141 to output a predetermined number of packets received by the reception section 110 all together to the second processing block 142 after the predetermined number of packets are received without any loss by the reception section 110.

For example, the transmitter 200 for which the re-ordering process is to be disabled may be specified. In this case, if device identification information adapted to identify the transmitter 200 is included in a predetermined request, it is only necessary for the detection section 170 to further detect the device identification information. Also, it is only necessary for the control section 150 to control the first processing block 141 to output a packet, received by the reception section 110, to the second processing block 142 each time the reception section 110 receives a packet from the transmitter 200 identified by the device identification information. On the other hand, if a packet is received from the transmitter 200 identified by device identification information that was not detected from a predetermine request, it is only necessary for the control section 150 to control the first processing block 141 to output a predetermined number of packets received by the reception section 110 all together to the second processing block 142 after the predetermined number of packets are received without any loss by the reception section 110. The MAC address of the transmitter 200 can be used, for example, as device identification information adapted to identify the transmitter 200. The machine name or IP address of the transmitter 200 may also be used rather than the MAC address.

Further, for example, the packet type for which the re-ordering process is to be disabled may be specified. If type information indicating a packet type is included in a predetermined request, it is only necessary for the detection section 170 to further detect the type information from the predetermined request. Also, it is only necessary for the control section 150 to control the first processing block 141 to output a packet, received by the reception section 110, to the second processing block 142 each time the reception section 110 receives a packet indicated by the type information. On the other hand, if a packet is received whose type is other than that indicated by the type information, it is only necessary for the control section 150 to control the first processing block 141 to output a predetermined number of packets received by the reception section 110 all together to the second processing block 142 after the predetermined number of packets are received without any loss by the reception section 110. A traffic ID (TID) equivalent to an ID adapted to identify the queue in which a packet is to be stored can be used as type information indicating the packet type. A port number may also be used rather than a TID.

Moreover, the data processing section 140 is capable of generating a packet to be transmitted to the transmitter 200 as necessary. Each of Ack and block Ack is equivalent to a packet to be transmitted to the transmitter 200.

In the transmission operation, the transmission processing section 130 performs processes including attaching a header and error detection code to the packets generated by the data processing section 140, supplying the processed data to the wireless interface section 120. The wireless interface section 120 modulates the data received from the transmission processing section 130 into a modulated signal, transmitting the modulated signal to the transmitter 200. In the reception operation, the wireless interface section 120 demodulates the signal received from the transmitter 200. The transmission processing section 130 analyzes the header in the received signal, passing the received signal to the data processing section 140.

The transmission processing section 130 handles such processes as generation and decomposition of an A-MPDU frame used in the throughput enhancement technique defined in 802.11n and buffer management and window management for block Ack. On the other hand, the first processing block 141 performs a sequence control process (re-ordering process) on packets at the time of reception as described above.

The storage section 160 can store a variety of programs adapted to allow for the receiver 100 to function as intended. The variety of programs stored in the storage section 160 are used, for example, to implement the functionality of the transmission processing section 130, data processing section 140, control section 150 and detection section 170. The storage section 160 includes, for example, a storage device such as HDD (Hard Disk Drive).

The input section 180 is capable of accepting an operation signal input from the user. The same section 180 includes, for example, input devices such as buttons, keyboard and mouse. The input section 180 outputs the operation signal fed from the user to the detection section 170. It should be noted that if the detection section 170 detects a predetermined request based on the operation signal output from the input section 180, the same section 180 is necessary. However, if the detection section 170 detects a predetermined request by any other method, it is not particularly necessary for the receiver 100 to include the input section 180.

The output section 190 is capable of outputting information to the user under control of the control section 150. The same section 190 includes, for example, output devices such as display and speaker. It should be noted that it is not particularly necessary for the receiver 100 to include the output section 190.

### 1-4. Functional Configuration of the Transmitter

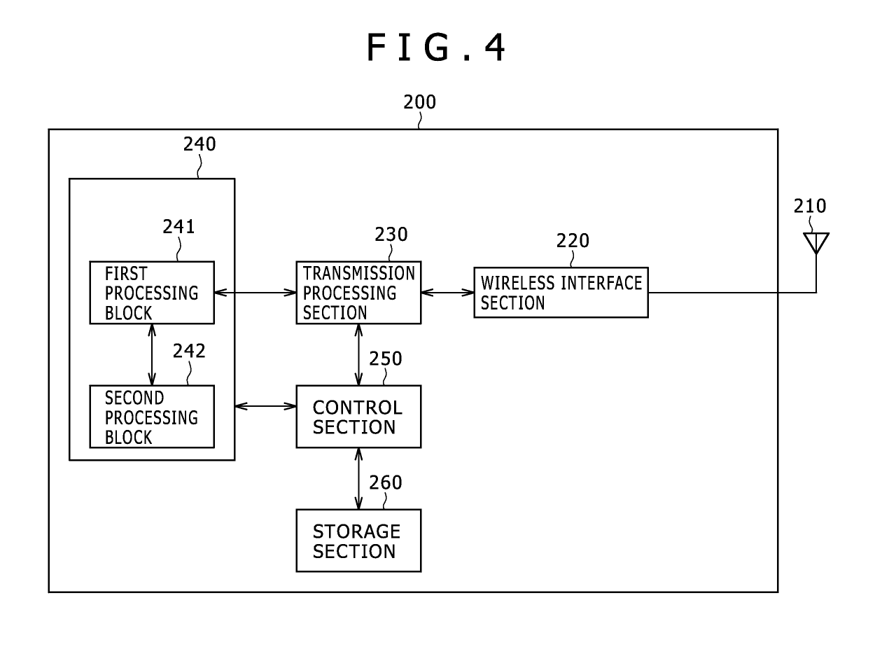

FIG. 4 is a diagram illustrating the functional configuration of the transmitter 200 according to the embodiment of the present disclosure. A description will be given below of the functional configuration of the transmitter 200 according to the embodiment of the present disclosure with reference to FIG. 4.

As illustrated in FIG. 4, the transmitter 200 according to the embodiment of the present disclosure includes at least a transmission section 210. The transmitter 200 further includes, for example, a wireless interface section 220, transmission processing section 230, data processing section 240, control section 250 and storage section 260 as necessary.

The transmission section 210 is capable of sequentially transmitting a plurality of packets to the receiver 100. Here, each of the plurality of packets sequentially transmitted by the transmission section 210 to the receiver 100 is equivalent to a frame payload in the example shown in FIG. 2. A preamble, PLCP header, MAC header and so on are attached to or removed from the frame payload as appropriate. For example, the transmitter 200 transmits a plurality of packets in the form of an A-MSDU, A-MPDU or other frame. The transmission section 210 includes, for example, an antenna as illustrated in FIG. 4. However, the same section 210 may include other communication device.

The data processing section 240 includes at least first and second processing blocks 241 and 242. The first processing block 241 outputs a plurality of packets sequentially generated by the second processing block 242 to the transmission processing section 230. The first processing block 241 is equivalent to the MAC layer. The second processing block 242 is capable of sequentially generating a plurality of packets. The same block 242 outputs the plurality of sequentially generated packets to the first processing block 241. The second processing block 242 is equivalent to the layer above the MAC layer.

In the transmission operation, the transmission processing section 230 performs processes including attaching a header and error detection code to the packets generated by the data processing section 240, supplying the processed data to the wireless interface section 220. The wireless interface section 220 modulates the data received from the transmission processing section 230 into a modulated signal, transmitting the modulated signal to the receiver 100. In the reception operation, the wireless interface section 220 demodulates the signal received from the receiver 100. The transmission processing section 230 analyzes the header in the received signal, passing the received signal to the data processing section 240.

The transmission processing section 230 handles such processes as generation and decomposition of an A-MPDU frame used in the throughput enhancement technique defined in 802.11n and buffer management and window management for block Ack.

The storage section 260 can store a variety of programs adapted to cause the transmitter 200 to function as intended. The variety of programs stored in the storage section 260 are used, for example, to implement the functionality of the transmission processing section 230, data processing section 240 and control section 250. The storage section 260 includes, for example, a storage device such as HDD.

### 1-5. Process Performed by the Communication System

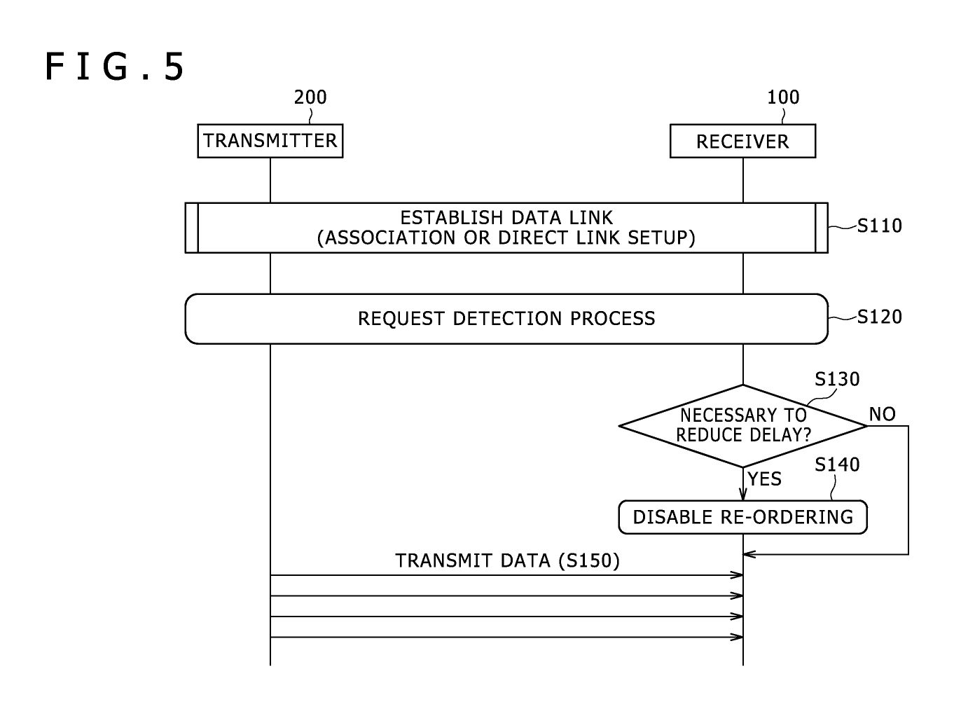

FIG. 5 is a flowchart illustrating the flow of a process performed by the communication system 10 according to the embodiment of the present disclosure. A description will be given below of the flow of the process performed by the communication system 10 according to the embodiment of the present disclosure with reference to FIG. 5.

As illustrated in FIG. 5, when a link is established between the transmitter 200 and receiver 100 (step 110), the transmitter 200 and receiver 100 can exchange data packets with each other. In this condition, the receiver 100 performs a request detection process (step S120). The request detection process is equivalent to the process performed by the detection section 170 to detect a predetermined request in the example described above. This process is designed to determine whether a low delay request has been made for the upper layer application which is about to be executed. The term “low delay request” refers, for example, to a request indicating that the processing delay should be maintained low.

When it is determined, as a result of the request detection process, that a low delay request has been made for the upper layer application which is about to be executed (Yes in step S130), the receiver 100 disables the re-ordering process (step S140). Then, the transmitter 200 transmits data packets (step S150). It should be noted that if whether a low delay request has been made for the upper layer application is determined based on the content of the data packets in the request detection process, the request detection process is performed after the start of transmission of the data packets, and the re-ordering process is disabled as necessary.

### 1-6. Detection of a Predetermined Request Based on User Input

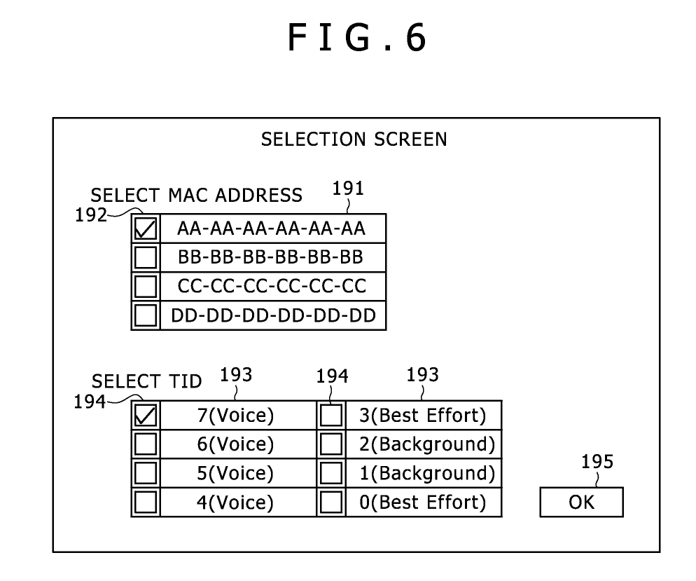

FIG. 6 is a diagram illustrating an example of a selection screen displayed by the receiver 100 according to the embodiment of the present disclosure. A description will be given below of a case in which a predetermined request is detected based on user input with reference to FIG. 6. It should be noted that a predetermined request in this example is equivalent to a low delay request made from the layer above the MAC layer as described above. The term “low delay request” refers, for example, to a request indicating that the processing delay should be maintained low.

Various situations are possible as a case in which a predetermined request is detected by the detection section 170 as described above. For example, the detection section 170 can detect a predetermined request based on user input. In this case, the receiver 100 further includes the input section 180 adapted to receive an operation signal input from the user. Further, the detection section 170 detects a predetermined request based on the operation signal accepted by the input section 180.

For example, the control section 150 displays a selection screen as shown in FIG. 6 on the output section 190. The selection screen includes, for example, MAC addresses 191 for selection of the transmitter 200, i.e., the source of the packets, for which the re-ordering process is to be disabled. The user viewing the selection screen can, for example, put a check mark in one of checkboxes 192 and press an OK button 195 on the input section 180. This operation makes it possible for the control section 150 to disable the re-ordering process for the packets transmitted from the transmitter 200 specified by the MAC address 191 with a check mark in the checkbox 192.

The selection screen includes, for example, traffic IDs (TIDs) 193 of the packets for which the re-ordering process is to be disabled. Each of the TIDs 193 is equivalent to an ID adapted to identify the queue in which the packet is to be stored. The user viewing the selection screen can, for example, put a check mark in one of checkboxes 194 and press the OK button 195 on the input section 180. This operation makes it possible for the control section 150 to disable the re-ordering process for the packets having the TID with a check mark in the checkbox 194.

Other information can be used rather than the MAC address 191. For example, the machine name or IP address of the transmitter 200 may be used rather than the MAC address 191. Further, other information can be used rather than the TID 193. For example, a port number may be used rather than the TID 193.

### 1-7. Detection of a Predetermined Request Based on the Setting in a Predetermined Field

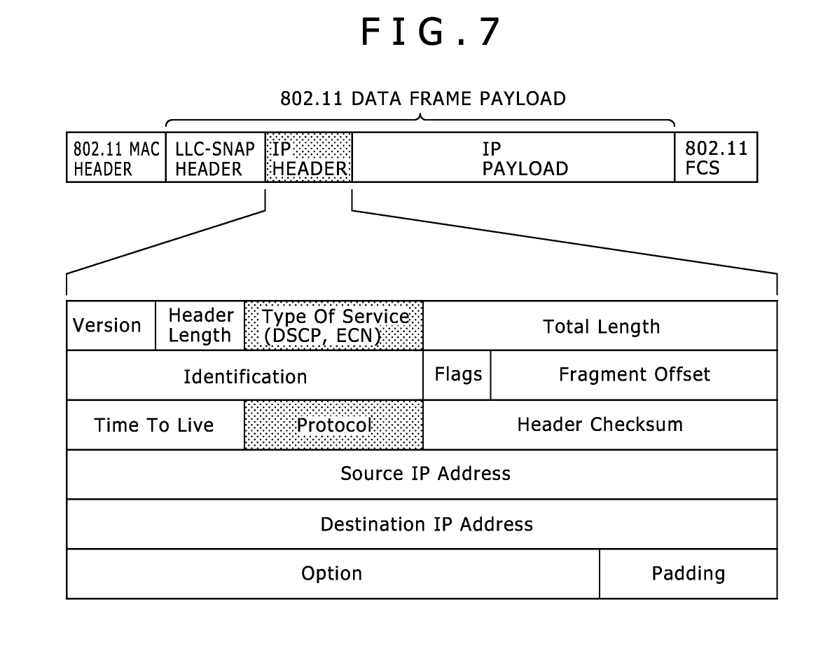

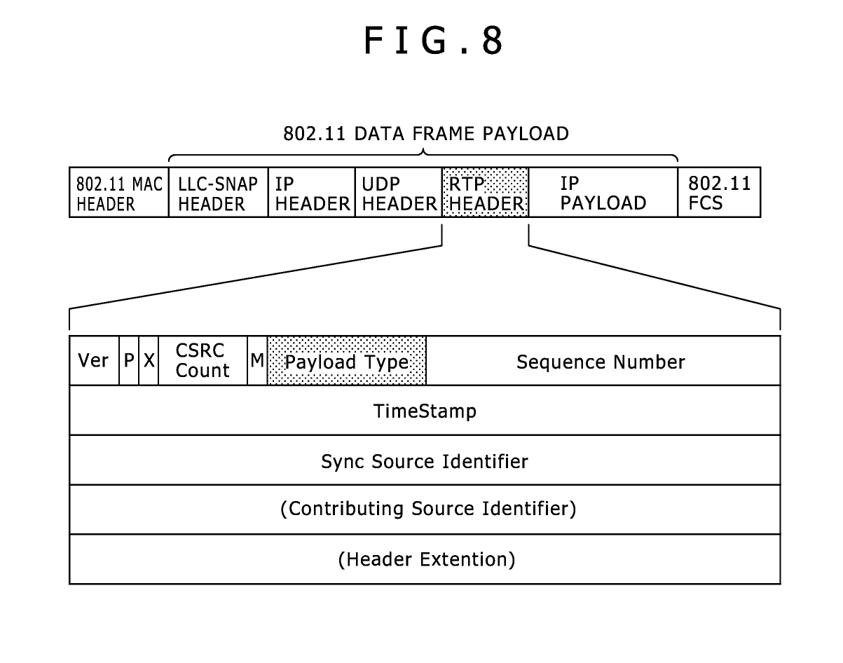

FIG. 7 is a diagram illustrating a configuration example of a data frame (including an IP header) applicable to the embodiment of the present disclosure. FIG. 8 is a diagram illustrating a configuration example of a data frame (including an RTP header) applicable to the embodiment of the present disclosure. A description will be given below of a case in which a predetermined request is detected based on the setting in a predetermined field with reference to FIGS. 7 and 8. It should be noted that a predetermined request in this example is equivalent to a low delay request made from the layer above the MAC layer as described above. The term “low delay request” refers, for example, to a request indicating that the processing delay should be maintained low.

Various situations are possible as a case in which a predetermined request is detected by the detection section 170 as described above. For example, the detection section 170 can detect a predetermined request based on the setting in a predetermined field of the packets used to transmit data from the transmitter 200 to the receiver 100. In this case, the detection section 170 detects a predetermined request based on the setting in a predetermined field in each of a plurality of packets received by the reception section 110 from the transmitter 200.

In this method, the receiver 100 detects a predetermined request from the data itself transmitted from the transmitter 200 to the receiver 100 rather than detecting a predetermined request before data transmission from the transmitter 200. Therefore, a field adapted to convey a low delay request is made available in one of the header portions used at the upper layer. The setting in this field is interpreted by the receiver 100, thus detecting a predetermined request. When detecting a predetermined request, the receiver 100 switches the current operation over to the operation intended for a low delay application (disabling of the re-ordering process).

Information used in the packets from which a predetermined request is detected is applicable as information (e.g., information adapted to specify the transmitter 200 from which data is to be transmitted such as MAC address and TID) adapted to restrict for which packets the re-ordering process is to be disabled. Among possible cases in which a field adapted to convey a low delay request is made available in one of the header portions used at the upper layer is that in which the Type Of Service field and Protocol field in the IP header are used as shown in FIG. 7. For example, if a value indicating that priority should be given to low delay is set in the Type Of Service field, and if a value indicating UDP is set in the Protocol field, it is possible to determine that low delay is necessary. Further, a value adapted to convey a low delay request may be set in the Payload Type field of the RTP header.

### 1-8. Detection of a Predetermined Request Based on Reception of a Dedicated Message

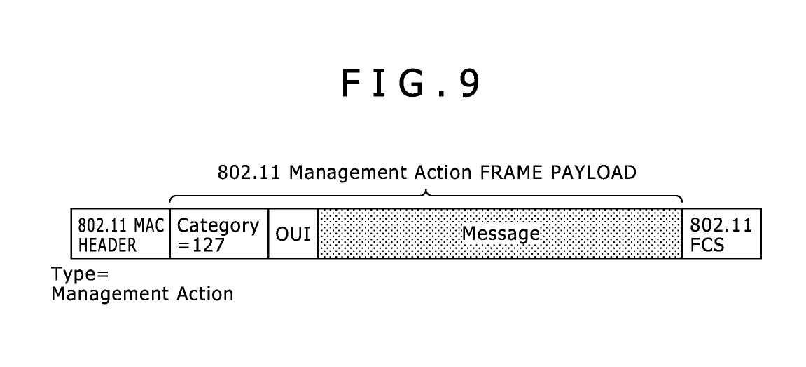

FIG. 9 is a diagram illustrating a configuration example of a management action frame applicable to the embodiment of the present disclosure. A description will be given below of a case in which a predetermined request is detected based on reception of a dedicated message with reference to FIG. 9. It should be noted that a predetermined request in this example is equivalent to a low delay request made from the layer above the MAC layer as described above. The term “low delay request” refers, for example, to a request indicating that the processing delay should be maintained low.

Various situations are possible as a case in which a predetermined request is detected by the detection section 170 as described above. For example, the detection section 170 can detect a predetermined request based on reception of a dedicated message transmitted from the transmitter 200. In this case, the reception section 110 further receives a predetermined message from the transmitter 200 to notify a predetermined request. The detection section 170 detects a predetermined request based on the predetermined message received by the reception section 110 from the transmitter 200.

In this method, the transmitter 200 transmits, for example, as a message, a request indicating that the re-ordering process should be disabled, to the receiver 100 before data transmission from the transmitter 200. The receiver 100 interprets the message from the transmitter 200, disabling the re-ordering process for the packets transmitted from the transmitter 200, i.e., the source of the message, according to the instruction in the message. In this case, the re-ordering process is disabled for all the packets transmitted from the transmitter 200, i.e., the source of the message. As a result, it is likely that the re-ordering process may be disabled for other packets from the transmitter 200, i.e., the source of the message, for which it is not necessary to do so. In order to avoid this problem, the transmitter 200 may include a TID in the message to disable the re-ordering process for the packets having that TID, thus restricting the range of packets.

The Management Action frame, a management frame that does not go up to the layer above the MAC layer, can be used as a frame adapted to include a message as illustrated, for example, in FIG. 9. If the Management Action frame is used, setting “127” in the Category field, for example, allows for the vendor to implement this frame on its own. For example, the Message field following the OUI (Organizationally Unique Identifier), used to identify the vendor, can be used as a field for the predetermined message.

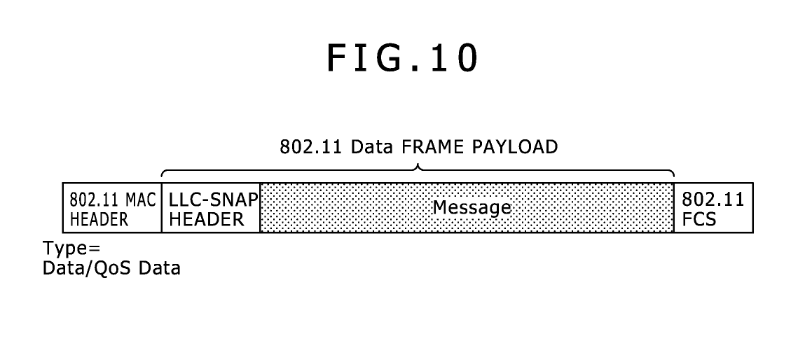

A data frame as shown, for example, in FIG. 10 can be used as a frame adapted to include a message. In this case, for example, the transmitter 200 encapsulates a message in the portion of the data frame (e.g., portion following the LLC-SNAP header) handled by the layer above the MAC layer, transmitting the data frame to the receiver 100.

### 1-9. Recovery of a Missing Packet

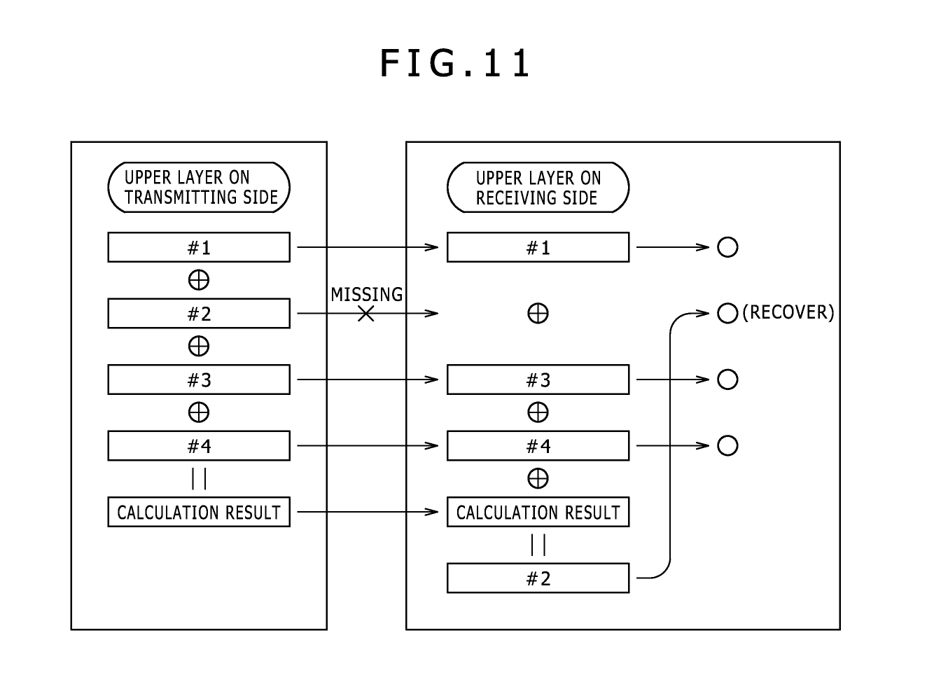

FIG. 11 is a diagram for describing the recovery of a missing packet by the receiver 100 according to the embodiment of the present disclosure. A description will be given below of the recovery of a missing packet by the receiver 100 according to the embodiment of the present disclosure with reference to FIG. 11. It should be noted that the recovery method of a missing packet described here is merely an example, and the recovery method of a missing packet used by the receiver 100 according to the embodiment of the present disclosure is not limited to that described here.

If the first processing block 141 is controlled by the control section 150 to output a packet, received by the reception section 110, to the second processing block 142 each time the reception section 110 receives a packet, there may be a packet that is not output from the first processing block 141. In this case, the second processing block 142 can, for example, recover the packet not output from the first processing block 141. For example, if the reception section 110 further receives, from the transmitter 200, a calculation result obtained by calculating the bit-by-bit exclusive OR of the predetermined number of packets, the second processing block 142 calculates the bit-by-bit exclusive OR of the plurality of packets output from the first processing section and the calculation result, thus recovering the packet not output from the first processing block 141.

More specifically, if the transmitter 200 transmits four packets, namely, packets #1 to #4, the first processing block 241 (shown as “Upper Layer on Transmitting Side” in FIG. 11) of the transmitter 200 calculates the exclusive OR of the packets #1 to #4, transmitting the calculation result obtained by the calculation to the receiver 100 in the form of a packet. Even if, for example, the packet #2 fails to reach the receiver 100 due to loss, the first processing block 141 (shown as “Upper Layer on Receiving Side” in FIG. 11) of the receiver 100 can recover the packet #2 as a calculation result obtained by calculating the exclusive OR of the packets #1, #3 and #4 and the calculation result.

### 1-10. Flow of Packets Transmitted and Received Before the Detection of a Predetermined Request

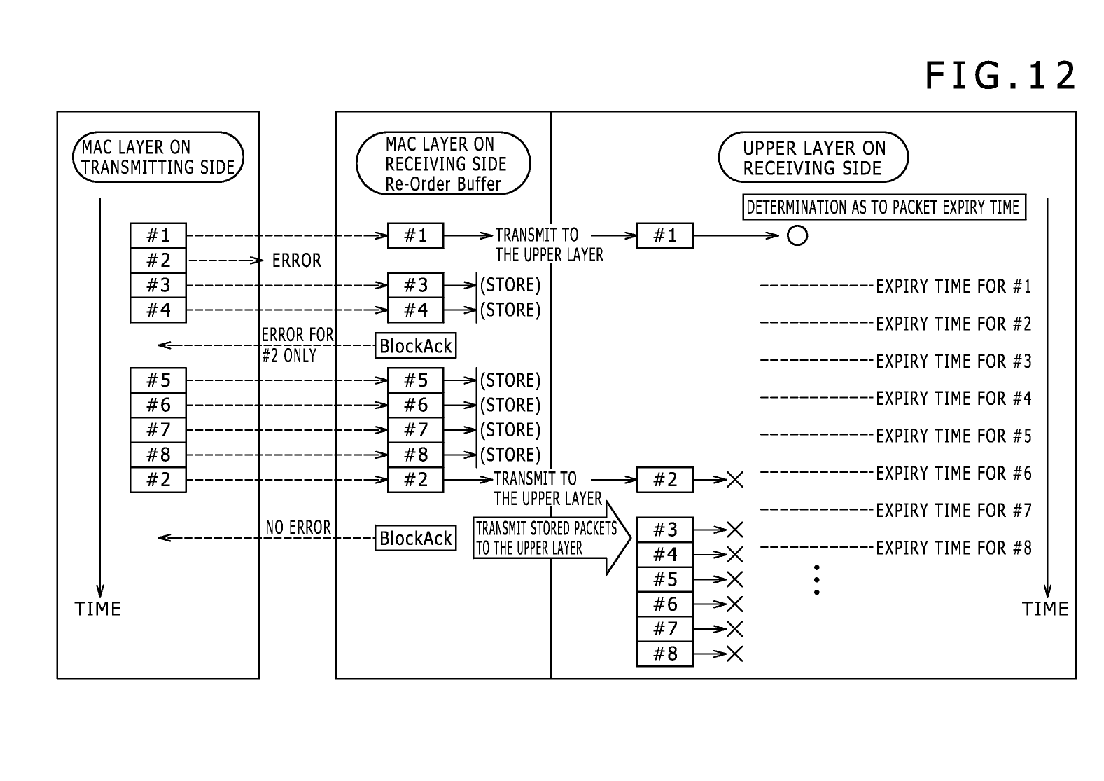

FIG. 12 is a diagram illustrating an example of flow of packets transmitted and received by the communication system 10 according to the embodiment of the present disclosure (before the detection of a predetermined request). A description will be given below of an example of flow of packets transmitted and received by the communication system according to the embodiment of the present disclosure (before the detection of a predetermined request) with reference to FIG. 12.

We assume that a data link has been established between the transmitter 200 and receiver 100 and that aggregation and block Ack can be already used. In the example shown in FIG. 12, the transmitter 200 is transmitting packets #1 to #8. We assume that the packets #1 to #4 are joined together through aggregation and transmitted. Here, an error occurs because the receiver 100 fails to properly demodulate the packet #2.

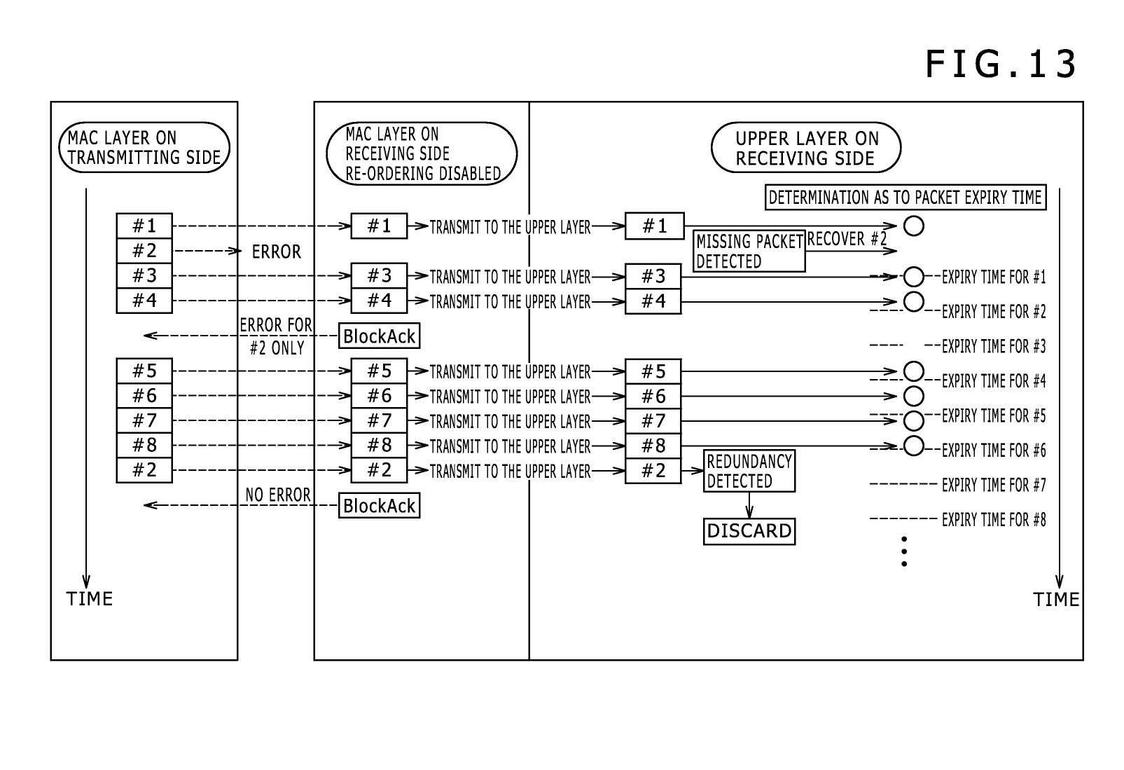

It should be noted that the receiver 100 can transmit a response packet (block ACK) to the transmitter 200 in response to a predetermined number of packets transmitted from the transmitter 200 using an unshown transmission section. The receiver 100 can transmit a response packet (block ACK) irrespective of whether a predetermined request has yet to be or has been detected by the detection section 170. FIG. 12 shows an example of flow of packets before the detection of a predetermined request by the detection section 170. FIG. 13 shows an example of flow of packets after the detection of a predetermined request by the detection section 170.

As described above, irrespective of whether a predetermined request has yet to be or has been detected by the detection section 170, the first processing block 141 can determine, by transmitting a response packet (block ACK), whether there is any missing packet, i.e., a packet that has not been received by the reception section 110, among the predetermined number of packets. The first processing block 141 can set a sequence number for a missing packet in the response packet (block ACK) if the same block 141 determines that there is a missing packet. On the other hand, the first processing block 141 can set, in the response packet (block ACK), information indicating that the packets have been received without any loss when the same block 141 determines that there is no missing packet.

The receiver 100 transfers the properly received packets to the upper layer so long as the condition that the packets are in an orderly sequence is satisfied. Here, the packet #1 is transferred immediately to the upper layer. However, the packets #3 and #4 may not be transferred to the upper layer even if they have already reached the receiver 100 because the packet #2 has yet to arrive at the receiver 100. Further, the receiver 100 transmits, to the transmitter 200, a block ACK to inform the transmitter 200 as to whether each of the four packets has been successfully received.

Here, the transmitter 200 is informed that the packet #2 failed to reach the receiver 100 due to error. As a result, the transmitter 200 learns that it is necessary to retransmit the packet #2. Next, the transmitter 200 transmits packets #5 to #8. Because the transmitter 200 also retransmits the packet #2, the same section 200 aggregates all the packets into one packet and transmits that packet. The sequence in which the packet to be retransmitted and others to be transmitted anew are to be transmitted may depend on the implementation. Therefore, it is likely that the retransmission of the packet #2 may be delayed.

In the example shown in FIG. 12, the packet #2 is transmitted after the packet #8. Therefore, the packet #2 arrives last at the receiver 100. During this period, despite the fact that all the data packets up to the packet #8 have already arrived, these packets remain stored in the buffer of the receiver 100. The packets #3 to #8 are transferred all together after the packet #2 reaches the receiver 100 and is transferred to the upper layer. However, this leads to needless delay during this period. A low delay application is executed at the upper layer. If the application has a rigorous packet time limit, as illustrated in FIG. 12, information including the packets #3 to #8 which could otherwise be used cannot reach the upper layer within the time limit while waiting for the packet #2 to arrive, possibly resulting in the packets #2 to #8 being discarded all together.

### 1-11. Flow of Packets Transmitted and Received After the Detection of a Predetermined Request

FIG. 13 is a diagram illustrating an example of flow of packets transmitted and received by the communication system 10 according to the embodiment of the present disclosure (after the detection of a predetermined request). A description will be given below of an example of flow of packets transmitted and received by the communication system according to the embodiment of the present disclosure (after the detection of a predetermined request) with reference to FIG. 13.

As illustrated in FIG. 13, when the receiver 100 disables the re-ordering process as a result of detection of a predetermined request, the packet sequence is not guaranteed at the upper layer. Instead, however, it is possible to transfer the packets one after another to the upper layer. This contributes to significantly reduced delay time for the packets to reach the upper layer application. The example shown in FIG. 13 is identical to that shown in FIG. 12 in that the packet #2 fails to reach the receiver 100 due to error. However, the packets #3 to #8 reach the upper layer immediately, allowing these packets to arrive in time before the time limit of the upper layer application runs out.

The packet #2 has yet to reach the receiver 100 due to error. However, if the receiver 100 detects, for example, the loss of a single packet, the receiver 100 can recover the missing packet by adding a simple parity packet. The recovery method of a missing packet is applicable to the pattern shown in FIG. 12. In this case, however, the packets #2 to #8 are lost in a burst manner all together. As a result, it is difficult to recover all the missing packets by adding simple parity packets.

For example, if the transmitter 200 retransmits a missing packet based on the sequence number set in the response packet, the receiving section 110 can receive the missing packet. In this case, if the first processing block 141 is controlled by the control section 150 to output a packet, received by the reception section 110, to the second processing block 142 each time the reception section 110 receives a packet, the second processing block 142 can recover a packet not output from the first processing block 141 and discard the missing packet received by the reception section 110.

As illustrated in FIG. 13, the real packet #2 (not the recovered packet #2) is transferred late from the MAC layer to the upper layer. However, a low delay application can be executed efficiently at the upper layer by combining the detection of redundancy between the recovered and real packets #2 and the discarding of the real packet #2.

### 2. MODIFICATION EXAMPLE

Although the preferred embodiment of the present disclosure has been described above in detail with reference to the accompanying drawings, the present disclosure is not limited to this example. It is obvious that those skilled in the art can make various modifications and alterations to the embodiment without departing from the scope of the present disclosure, and it will be naturally understood that these modifications and alterations are also included in the technical scope of the present disclosure.

### 3. SUMMARY

The preferred embodiment of the present disclosure can prevent received packets from waiting at the lower layer in the receiver 100 until a packet whose reception from the transmitter 200 failed once is received properly as a result of retransmission in response to a predetermined request. More specifically, if the upper layer is an application for which realtimeness is important, packets can be transferred to the upper layer speedily in response to a predetermined request. Further, a packet that fails to reach the receiver 100 can be recovered. This contributes to reduced delay time of the communication system 10 as a whole.

The present disclosure contains subject matter related to that disclosed in Japanese Priority Patent Application JP 2010-262782 filed in the Japan Patent Office on Nov. 25, 2010, the entire content of which is hereby incorporated by reference.

What is claimed is:

1. A receiver comprising:
a reception section adapted to sequentially receive a plurality of packets from a transmitter;
a first processing section adapted to output a predetermined number of packets received by the reception section all together if the predetermined number of packets are received without any loss by the reception section;
a second processing section adapted to accept the predetermined number of packets output all together from the first processing section;
a detection section adapted to detect a predetermined request; and
a control section adapted to control the first processing section to output a packet, received by the reception section, to the second processing section each time the reception section receives a packet if the detection section detects the predetermined request.

2. The receiver of claim 1, wherein
the second processing section performs a predetermined process on the predetermined number of packets output from the first processing section before the detection of the predetermined request by the detection section, and performs a predetermined process on the packet output from the first processing section after the detection of the predetermined request by the detection section.

3. The receiver of claim 2, wherein
if the first processing section is controlled by the control section to output the packet, received by the reception section, to the second processing section each time the reception section receives the packet, the second processing section recovers a packet not output from the first processing section.

4. The receiver of claim 3, wherein
if the reception section further receives, from the transmitter, a calculation result obtained by calculating the bit-by-bit exclusive OR of the predetermined number of packets, the second processing section recovers a packet not output from the first processing section by calculating the bit-by-bit exclusive OR of the plurality of packets output from the first processing section and the calculation result.

5. The receiver of claim 1, wherein
if a sequence number is assigned to each of the plurality of packets transmitted from the transmitter, the first processing section determines whether the predetermined number of packets have been received without any loss based on the sequence number assigned to each of the plurality of packets.

6. The receiver of claim 1 further comprising:
an input section adapted to accept an operation signal input from the user,
wherein the detection section detects the predetermined request based on the operation signal accepted by the input section.

7. The receiver of claim 1, wherein
the reception section further receives a predetermined message from the transmitter for notification of the predetermined request, and
the detection section detects the predetermined request based on the predetermined message received by the reception section from the transmitter.

8. The receiver of claim 1, wherein
the detection section detects the predetermined request based on a setting in a predetermined field of each of the plurality of packets received by the reception section from the transmitter.

9. The receiver of claim 1, wherein
if device identification information adapted to identify the transmitter is included in the predetermined request, the detection section further detects the device identification information from the predetermined request, and
the control section controls the first processing section to output the packet, received by the reception section, to the second processing section each time the reception section receives the packet from the transmitter identified by the device identification information.

10. The receiver of claim 1, wherein
if type information indicating the type of the packet is included in the predetermined request, the detection section further detects the type information from the predetermined request, and wherein
the control section controls the first processing section to output a packet, received by the reception section, to the second processing section each time the reception section receives the packet whose type is indicated by the type information.

11. The receiver of claim 1 further comprising:
a transmission section adapted to transmit a response packet to the transmitter in response to the predetermined number of packets transmitted from the transmitter irrespective of whether the detection section has yet to detect or has already detected the predetermined request.

12. The receiver of claim 11, wherein
the first processing section determines whether there is any missing packet that has not been received by the reception section, among the predetermined number of packets,
the first processing section sets a sequence number for the missing packet in the response packet if the first processing section determines that there is a missing packet, and
the first processing section sets, in the response packet, information indicating that the packets have been received without any loss when the first processing section determines that there is no missing packet.

13. The receiver of claim 12, wherein
if the missing packet is retransmitted from the transmitter based on the sequence number set in the response packet, the reception section receives the missing packet, and
if the first processing section is controlled by the control section to output the packet, received by the reception section, to the second processing section each time the reception section receives the packet, the second processing section recovers a packet not output from the first processing section and discards the missing packet received by the reception section.

14. A reception method comprising:
sequentially receiving a plurality of packets from a transmitter;
outputting a predetermined number of packets all together if the predetermined number of packets are received without any loss by the reception section;
accepting the predetermined number of packets output all together;
detecting a predetermined request; and
controlling to output a received packet each time the packet is received if the predetermined request is detected.

15. A program causing a computer to function as a receiver, the receiver comprising:
a reception section adapted to sequentially receive a plurality of packets from a transmitter;
a first processing section adapted to output a predetermined number of packets received by the reception section all together if the predetermined number of packets are received without any loss by the reception section;
a second processing section adapted to accept the predetermined number of packets output all together from the first processing section;
a detection section adapted to detect a predetermined request; and
a control section adapted to control the first processing section to output a packet, received by the reception section, to the second processing section each time the reception section receives a packet if the detection section detects the predetermined request.

16. A communication system comprising:
a transmitter; and
a receiver, wherein
the transmitter includes a transmission section adapted to sequentially transmit a plurality of packets, and
the receiver includes
a reception section adapted to sequentially receive a plurality of packets from a transmitter,
a first processing section adapted to output a predetermined number of packets received by the reception section all together if the predetermined number of packets are received without any loss by the reception section,
a second processing section adapted to accept the predetermined number of packets output all together from the first processing section,
a detection section adapted to detect a predetermined request, and
a control section adapted to control the first processing section to output a packet, received by the reception section, to the second processing section each time the reception section receives a packet if the detection section detects the predetermined request.
